(19) United States
(12) Patent Application Publication
(10) Pub. No.: US 2026/0366357 A1
(43) Pub. Date: Nov. 19, 2026

(54) REMOTE CONTROL DOOR SYSTEM FOR OPENING BUTTON-ACTIVATED DOORS IN A MEDICAL FACILITY AND METHOD THEREFOR

(71) Applicant: Termaine Todd, Lafayette, IN (US)

(72) Inventor: Termaine Todd, Lafayette, IN (US)

(21) Appl. No.: 19/207,524

(22) Filed: May 14, 2025

(51) Int. Cl. E05F 15/77; A61G 7/05

(52) U.S. Cl. CPC E05F 15/77; A61G 7/05; E05Y 2400/30; E05Y 2400/66; E05Y 2400/8505; E05Y 2400/854; E05Y 2600/40; E05Y 2900/132

(57) ABSTRACT

A remote control door system for opening button-activated doors in a medical facility includes a controller, a receiver, and a remote control. The controller is designed to activate a motorized door opener to open button-activated doors in a medical facility. The remote control is designed to send a signal to the controller to activate the motorized door opener. The remote control includes a push handle, a controller, a transmitter, an activator, and a battery. The push handle is designed to be attached to a wheeled transport bed. The controller, the transmitter, and the battery are mounted in the push handle. The activator is mounted on the push handle. The activator is designed to be selectively engaged to cause the controller to send a signal wirelessly via the transmitter to the receiver to activate the motorized door opener to open the button-activated doors.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to controls for button-activated doors in medical facilities and more particularly pertains to a new remote control door system for remotely opening button-activated doors in medical facilities. In many medical facilities, such as hospitals, sections of the medical facility are divided by powered doors that are openable only by pushing a door button, usually mounted in a wall near the powered doors. Such a design is good for security but can be problematic for medical personnel who need to move quickly through the doors, such as in an emergency situation, especially if the medical personnel are pushing a patient on a wheeled transport bed, such as a gurney or similar.

The new remote control door system allows medical personnel to remotely activate and open the powered doors without needing to press the door button

### (2) Description of Related Art Including information Disclosed Under 37 CFR 1.97 and 1.98

The prior art relates to controls for button-activated doors in medical facilities. The prior art, as best understood, does not disclose a remote control door system that includes a controller, a receiver, and a remote control. The controller is designed to activate a motorized door opener to open button-activated doors in a medical facility. The remote control includes a push handle, a controller, a transmitter, an activator, and a battery. The push handle is designed to be attached to a wheeled transport bed. The activator is mounted on the push handle. The activator is designed to be selectively engaged to cause the controller to send a signal wirelessly via the transmitter to the receiver to activate the motorized door opener to open the button-activated doors.

### (h) BRIEF SUMMARY OF THE INVENTION

An embodiment of the disclosure meets the needs presented above in a remote control door system generally comprising a controller, a receiver, and a remote control. The controller is designed to activate a motorized door opener to open button-activated doors in a medical facility. The receiver is connected to the controller. The remote control is designed to send a signal to the controller to activate the motorized door opener. The remote control includes a push handle, a controller, a transmitter, an activator, and a battery. The push handle is designed to be attached to a wheeled transport bed. The controller is mounted in the push handle. The transmitter is mounted in the push handle. The transmitter is connected to the controller. The activator is mounted on the push handle. The activator is connected to the controller. The activator is designed to be selectively engaged to cause the controller to send a signal wirelessly via the transmitter to the receiver to activate the motorized door opener to open the button-activated doors. The battery is mounted in the push handle. The battery is connected to the controller and the transmitter to supply power.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a remote control door system according to an embodiment of the disclosure.

FIG. 2 is a top view of an embodiment of the disclosure in use.

FIG. 3 is a front perspective view of an alternative embodiment of the disclosure.

FIG. 4 is a rear perspective view of the alternative embodiment of the disclosure.

FIG. 5 is a schematic diagram of components of an embodiment of the disclosure.

### (j) DETAILED DESCRIPTION OF THE INVENTION

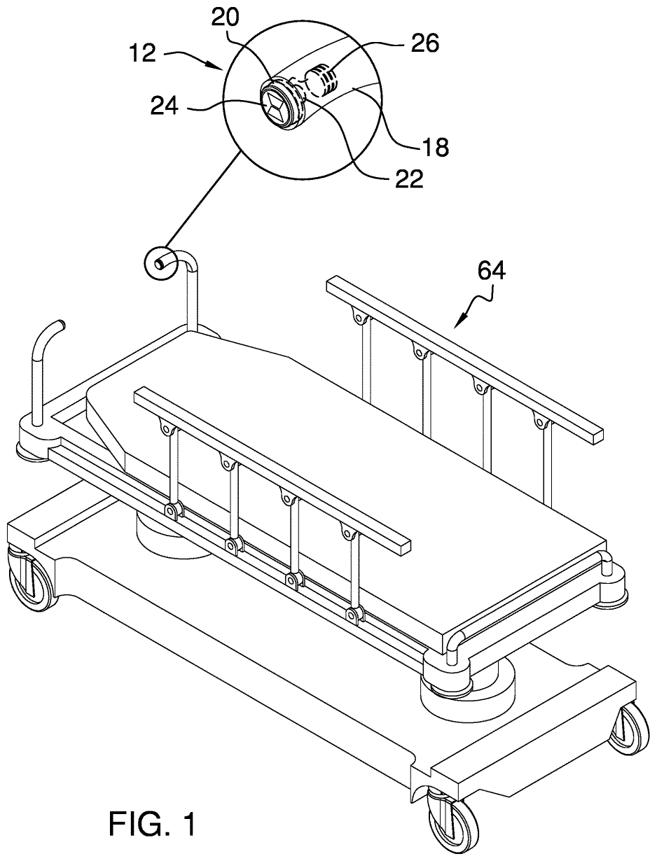

With reference now to the drawings, and in particular to FIGS. 1 through 5 thereof, a new remote control door system embodying the principles and concepts of an embodiment of the disclosure and generally designated by the reference numeral 10 will be described.

As best illustrated in FIGS. 1 through 5, the remote control door system 10 generally comprises a controller 12, a receiver 14, and a remote control 16. The controller 12 is designed to activate a motorized door opener 60 to open button-activated doors 62 in a medical facility. The receiver 14 is connected to the controller 12. The remote control 16 is designed to send a signal to the controller 12 to activate the motorized door opener 60.

In the exemplary embodiment in FIG. 1, the remote control 16 includes a push handle 18, a controller 20, a transmitter 22, an activator 24, and a battery 26. The push handle 18 is designed to be attached to a wheeled transport bed 64. The controller 20 is mounted in the push handle 18. The transmitter 22 is mounted in the push handle 18. The transmitter 22 is connected to the controller 20. The activator 24 is mounted on the push handle 18. The activator 24 is connected to the controller 20. The activator 24 is designed to be selectively engaged to cause the controller 20 to send a signal wirelessly via the transmitter 22 to the receiver 14 to activate the motorized door opener 60 to open the button-activated doors 62. The battery 26 is mounted in the push handle 18. The battery 26 is connected to the controller 20 and the transmitter 22 to supply power.

In the exemplary embodiment in FIG. 1, the activator 24 is a button positioned at an end of the push handle 18. This positioning allows engagement of the button with the thumb of a person grasping the push handle 18, such that the person can both push the wheeled transport bed 64 and open the doors 62 at the same time. However, the button could be positioned elsewhere, such as on the body of the push handle 18 for activation by one of the fingers. In another possible embodiment, the button could be replaced with a pivotable handle, like a hand brake on a bicycle.

In the exemplary embodiment in FIG. 1, the button is a push button that would need to be depressed for activation. However, in another possible embodiment, the button is a touch sensor that would simply need to be contacted by the thumb or finger of the user.

In one possible embodiment, the touch sensor could include a fingerprint sensor. Such a design would add a layer of biometric security to prevent activation and opening of the doors 62 by unauthorized users.

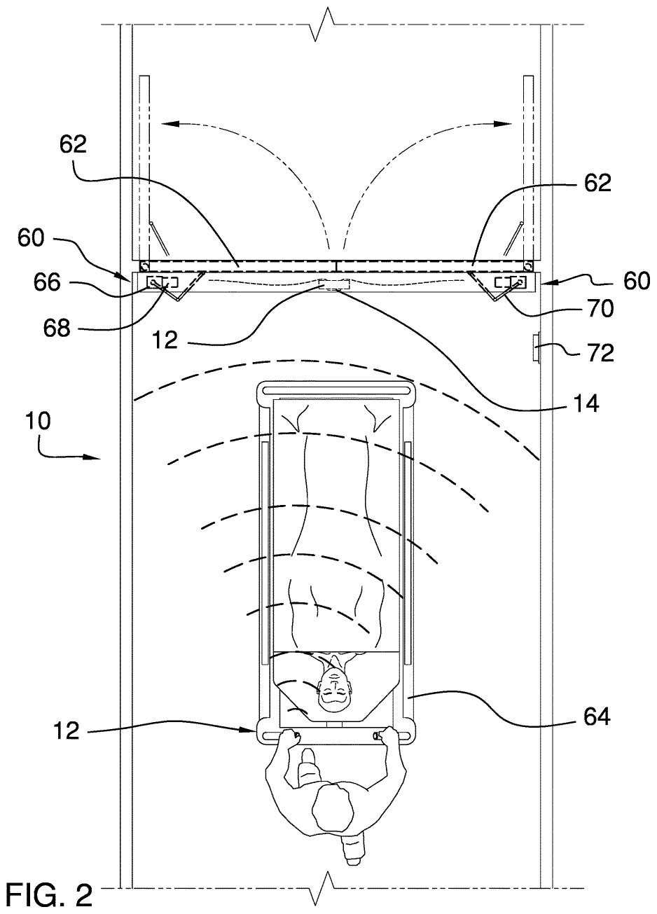

In the exemplary embodiment in FIG. 2, the transmitter 22 has an active range up to 20 feet from the receiver 14. This allows the user to activate and open the doors 62 before reaching the doors 62 so the user does not have to stop pushing the wheeled transport bed 64. In another possible embodiment, the active range could be more than 20 feet, which could be advantageous in emergency situations where the user is very quickly pushing the wheeled transport bed 64. In another possible embodiment, the activator 24 could be an automatic device that does not need to be activated by the user, but rather automatically sends out the opening signal when the wheeled transport bed 64 has been moved into the active range.

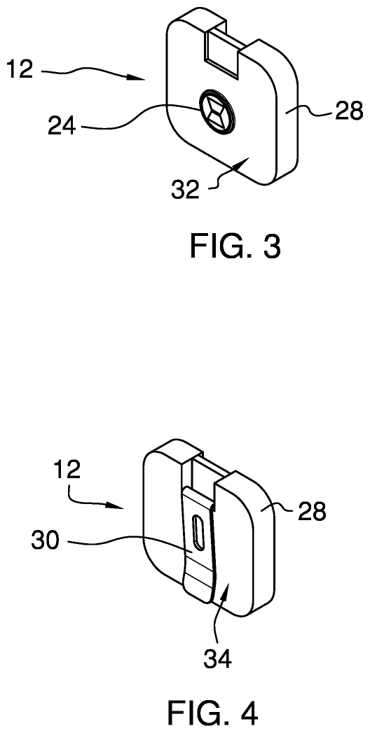

In an alternative embodiment shown in FIGS. 3 and 4, the push handle 18 could be replaced with a wearable housing 28. The controller 20, the transmitter 22, and the battery 26 would be mounted in the wearable housing 28, and the activator 24 would be mounted on the wearable housing 28.

The wearable housing 28 includes a coupler 30. The coupler 30 is designed to couple the wearable housing 28 to clothing. In the exemplary embodiment in FIGS. 3 and 4, the wearable housing 28 includes a front face 32 and a rear face 34. The coupler 30 is a clip attached to the rear face 34. The activator 24 is a button positioned in the front face 32. The button can be of any of the designs discussed herein with respect to the push handle 18.

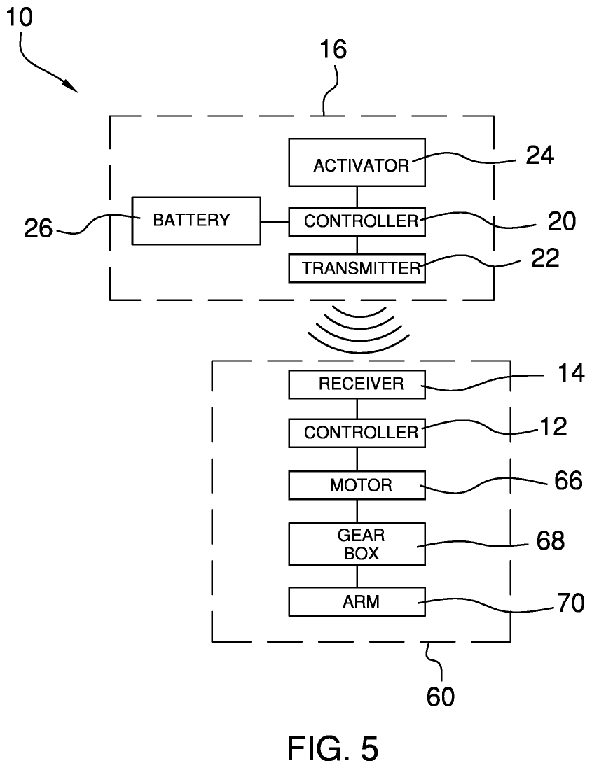

FIGS. 2 and 5 show the relationship and use of the components of the remote control door system 10 for remotely activating a motorized door opener 60. The motorized door opener 60 is of a known design and includes motors 66, gear boxes 68, and arms 70. The receiver 14 and the controller 12 are connected to the motorized door opener 60. The user grasps the push handle 18 and pushes the wheeled transport bed 64. In this case there are two push handles 18, but only one has the activator 24. The user manually engages the activator 24 when approaching the button-activated doors 62 in the medical facility. The signal is sent to activate the motorized door opener 60 to open the button-activated doors 62 without needing to press a door button 72 mounted adjacent the button-activated doors 62 and while still pushing the wheeled transport bed 64. As mentioned above, since the activator 24 is a button positioned at an end of the push handle 18, the user can engage the button with a thumb while grasping the push handle 18 with the other fingers and pushing the wheeled transport bed 64. The alternative embodiment of the wearable housing 28 can be used in much the same way to remotely open the button-activated doors 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A remote control door system comprising:
a controller, the controller being configured to activate a motorized door opener to open button-activated doors in a medical facility;
a receiver, the receiver being connected to the controller;
a remote control, the remote control being configured to send a signal to the controller to activate the motorized door opener, the remote control including:
a push handle, the push handle being configured to be attached to a wheeled transport bed;
a controller, the controller of the remote control being mounted in the push handle;
a transmitter, the transmitter being mounted in the push handle, the transmitter being connected to the controller of the remote control;
an activator, the activator being mounted on the push handle, the activator being connected to the controller of the remote control, the activator being configured to be selectively engaged to cause the controller of the remote control to send a signal wirelessly via the transmitter to the receiver to activate the motorized door opener to open the button-activated doors; and
a battery, the battery being mounted in the push handle, the battery being connected to the controller of the remote control and the transmitter to supply power.

2. The remote control door system of claim 1, wherein the activator is a button positioned at an end of the push handle.

3. The remote control door system of claim 2, wherein the button is a push button.

4. The remote control door system of claim 2, wherein the button is a touch sensor.

5. The remote control door system of claim 4, wherein the touch sensor includes a fingerprint sensor.

6. The remote control door system of claim 1, wherein the transmitter has an active range up to 20 feet from the receiver.

7. The remote control door system of claim 2, wherein the transmitter has an active range up to 20 feet from the receiver.

8. A method of remotely opening button-activated doors in a medical facility, the method comprising the steps of:
providing a remote control door system comprising:
a controller, the controller being configured to activate a motorized door opener to open button-activated doors in a medical facility;
a receiver, the receiver being connected to the controller; and
a remote control, the remote control being configured to send a signal to the controller to activate the motorized door opener, the remote control including:
a push handle, the push handle being configured to be attached to a wheeled transport bed;
a controller, the controller of the remote control being mounted in the push handle;
a transmitter, the transmitter being mounted in the push handle, the transmitter being connected to the controller of the remote control;
an activator, the activator being mounted on the push handle, the activator being connected to the controller of the remote control, the activator being configured to be selectively engaged to cause the controller of the remote control to send a signal wirelessly via the transmitter to the receiver to activate the motorized door opener to open the button-activated doors; and
a battery, the battery being mounted in the push handle, the battery being connected to the controller of the remote control and the transmitter to supply power;
grasping the push handle and pushing the wheeled transport bed; and
manually engaging the activator when approaching button-activated doors in a medical facility and thereby sending the signal to activate a motorized door opener to open the button-activated doors without needing to press a door button mounted adjacent the button-activated doors and while still pushing the wheeled transport bed.

9. The method of claim 8, wherein the activator is a button positioned at an end of the push handle, and the step of manually engaging the activator includes engaging the button with a thumb while grasping the push handle with the other fingers.

10. A remote control door system comprising:
a controller, the controller being configured to activate a motorized door opener to open button-activated doors in a medical facility;
a receiver, the receiver being connected to the controller;
a remote control, the remote control being configured to send a signal to the controller to activate the motorized door opener, the remote control including:
a wearable housing;
a controller, the controller of the remote control being mounted in the wearable housing;
a transmitter, the transmitter being mounted in the wearable housing, the transmitter being connected to the controller of the remote control;
an activator, the activator being mounted on the wearable housing, the activator being connected to the controller of the remote control, the activator being configured to be selectively engaged to cause the controller of the remote control to send a signal wirelessly via the transmitter to the receiver to activate the motorized door opener to open the button-activated doors; and
a battery, the battery being mounted in the wearable housing, the battery being connected to the controller of the remote control and the transmitter to supply power.

11. The remote control door system of claim 10, wherein:
the wearable housing includes a coupler; and
the coupler is configured to couple the wearable housing to clothing.

12. The remote control door system of claim 11, wherein:
the wearable housing includes a front face and a rear face;
the coupler is a clip attached to the rear face; and
the activator is a button positioned in the front face.

13. The remote control door system of claim 12, wherein the button is a push button.

14. The remote control door system of claim 12, wherein the button is a touch sensor.

15. The remote control door system of claim 14, wherein the touch sensor includes a fingerprint sensor.

16. The remote control door system of claim 10, wherein the transmitter has an active range up to 20 feet from the receiver.

17. The remote control door system of claim 12, wherein the transmitter has an active range up to 20 feet from the receiver.
